(19) United States
(12) Patent Application Publication
(10) Pub. No.: US 2020/0040148 A1
(43) Pub. Date: Feb. 6, 2020

(54) PLANT FIBER FOAM BOARD AND METHOD OF MAKING THE SAME

(71) Applicants: HSIEN-CHENG LIU, Kaohsiung City (TW); SHING YAU SPONGE ENTERPRISE CO., LTD., Changhua County (TW); BAOLIN BIOTECH CO., LTD., Pingtung County (TW)

(72) Inventor: CHIH-HUI KAO, Changhua County (TW)

(73) Assignees: SHING YAU SPONGE ENTERPRISE CO., LTD., Changhua County (TW); HSIEN-CHENG LIU, Kaohsiung City (TW); BAOLIN BIOTECH CO., LTD., Pingtung County (TW)

(21) Appl. No.: 16/413,198

(22) Filed: May 15, 2019

(30) Foreign Application Priority Data
Aug. 1, 2018 (TW) 107126776

(51) Int. Cl. C08J 5/04; C08J 9/10

(52) U.S. Cl. CPC C08J 5/045; C08J 9/103; C08K 2003/265; C08J 2331/04; C08J 2323/08

(57) ABSTRACT

A plant fiber foam board contains: plant fibers, Ethylene Vinyl Acetate (EVA) copolymer, calcium carbonate, blowing agent, and cross-linking agent which are mixed and molded in a high temperature and a high pressure. The plant fiber foam board includes multiple air holes foamed thereon, and the multiple air holes do not communicate with one another. A method of making the plant fiber foam board contains steps of: putting and mixing plant fibers, Ethylene Vinyl Acetate (EVA) copolymer, calcium carbonate, blowing agent, and cross-linking agent in a mixing machine so as to produce a semi-finished product; and putting the semi-finished product into a mold of a foaming machine so as to be heated and pressurized, such that multiple air holes are foamed on the semi-finished product, and the multiple air holes do not communicate with one another.

### CROSS REFERENCE TO RELATED APPLICATION

This application claims priority to Taiwan Patent Application No. 107126776, filed on Aug. 1, 2018. The entire contents of the above applications is hereby incorporated by reference.

### TECHNICAL FIELD

The present disclosure relates to a plant fiber foam board and a method of making the same.

### BACKGROUND

Conventional splicing mat sleeping mat, yoga mat, placemat, soft floor, soundproof board, and car mat are foamed from plastic material or rubber after adding blowing agent.

However, the plastic material will spread odor and cannot be decomposed, thus causing environmental pollution.

To overcome above-mentioned problem, an improved fiber particulate composite (FPC) is foamed with rubber so as to produce foaming mat, but these foaming mat spreads odor. Furthermore, the FPC cannot be pressurized and multiple air holes cannot communicate with one another, thus flowing water into the multiple air holes to cause mildew.

### SUMMARY

A primary aspect of the present invention is to provide a plant fiber foam board and a method of making the same which decompose the plant fiber foam board in nature.

Secondary aspect of the present invention is to provide a plant fiber foam board and a method of making the same which obtain flexibility and sound insulation to the plant fiber foam board.

Another aspect of the present invention is to provide a plant fiber foam board and a method of making the same which reduce a consumption of the EVA copolymer greatly.

Other objects and features will be in part apparent and in part pointed out hereinafter.

To obtain above-mentioned aspects, a plant fiber foam board provided by the present invention contains: plant fibers, Ethylene Vinyl Acetate (EVA) copolymer, calcium carbonate, blowing agent, and cross-linking agent which are mixed and molded in a high temperature and a high pressure. The plant fiber foam board includes multiple air holes foamed thereon, and the multiple air holes do not communicate with one another.

Preferably, a weight percent of the plant fibers is 30 wt % to 65 wt %, a weight percent of the EVA copolymer is 15 wt % to 70 wt %, and a weight percent of the calcium carbonate is 15 wt % to 35 wt %.

Preferably, the weight percent of the plant fibers is 50 wt %, the weight percent of the EVA copolymer is 15 wt %, and the weight percent of the calcium carbonate is 15 wt %.

Preferably, a diameter of each of the multiple air holes is 20 μm to 100 μm.

Preferably, the plant fibers are made of powdered plant fibers by grinding agricultural waste material, and the agricultural waste material is at least one of rice husk, wheat husk, sugarcane bagasse, cornstalk, and rice stalk.

Preferably, the blowing agent is azodicarbonamide (ADCA).

Preferably, the cross-linking agent is organic peroxide, and the organic peroxide is BIPB (bis(tert-butylperoxy isopropyl)benzene).

One aspect of present invention discloses a method of making the plant fiber foam board contains steps of:

putting and mixing plant fibers, Ethylene Vinyl Acetate (EVA) copolymer, calcium carbonate, blowing agent, and cross-linking agent in a mixing machine so as to produce a semi-finished product; and

putting the semi-finished product into a mold of a foaming machine so as to be heated and pressurized, such that multiple air holes are foamed on the semi-finished product, and the multiple air holes do not communicate with one another.

Preferably, the semi-finished product is put and is mixed in a rolling machine before putting the semi-finished product into the mold of the foaming machine so as to be heated and pressurized.

Preferably, the mixing machine is a kneader reactor configured to mix the plant fibers, the EVA copolymer, the calcium carbonate, the blowing agent, and the cross-linking agent, wherein a mixing time of the plant fibers, the EVA copolymer, the calcium carbonate, the blowing agent, and the cross-linking agent is 10 minutes to 14 minutes, and a mixing temperature of the plant fibers, the EVA copolymer, the calcium carbonate, the blowing agent, and the cross-linking agent is 120° C. to 140° C.

Preferably, the blowing agent is azodicarbonamide (ADCA) so as to avoid spreading odor of the plant fiber foam board.

Preferably, the cross-linking agent is organic peroxide, and the organic peroxide is BIPB (bis(tert-butylperoxy isopropyl)benzene) so as to reduce consumption of the EVA copolymer.

### BRIEF DESCRIPTION OF THE DRAWINGS

FIG. 1 is a perspective view showing the assembly of a part of a plant fiber foam board according to a preferred embodiment of the present invention.

FIG. 2 is a perspective view showing the exploded components of a part of the plant fiber foam board according to the preferred embodiment of the present invention.

FIG. 3 is a schematic view showing a method of making the plant fiber foam board according to the preferred embodiment of the present invention.

FIG. 4 is a flow chart of the method of making the plant fiber foam board according to the preferred embodiment of the present invention.

FIG. 5 is a cross sectional view showing the assembly of the plant fiber foam board according to the preferred embodiment of the present invention.

Corresponding reference characters indicate corresponding parts throughout the drawings.

### DETAILED DESCRIPTION

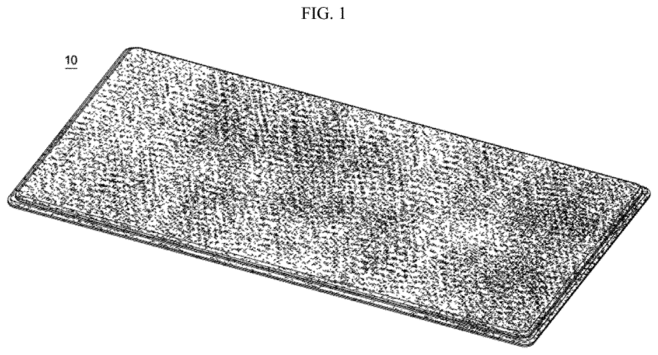

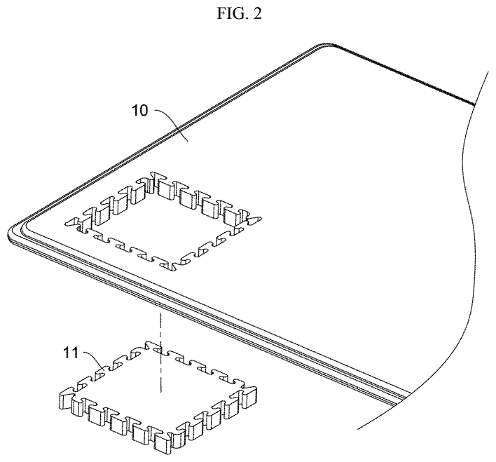

With reference to FIGS. 1 and 2, a plant fiber foam board 10 according to a preferred embodiment of the present invention is made by foaming a substrate in a mold and is cut in a desired size and a desired shape.

For example, the substrate is cut to form a splice mat 11. Alternatively, the substrate is cut to form any one of sleeping mat, yoga mat, placemat, soft floor, soundproof board, and car mat.

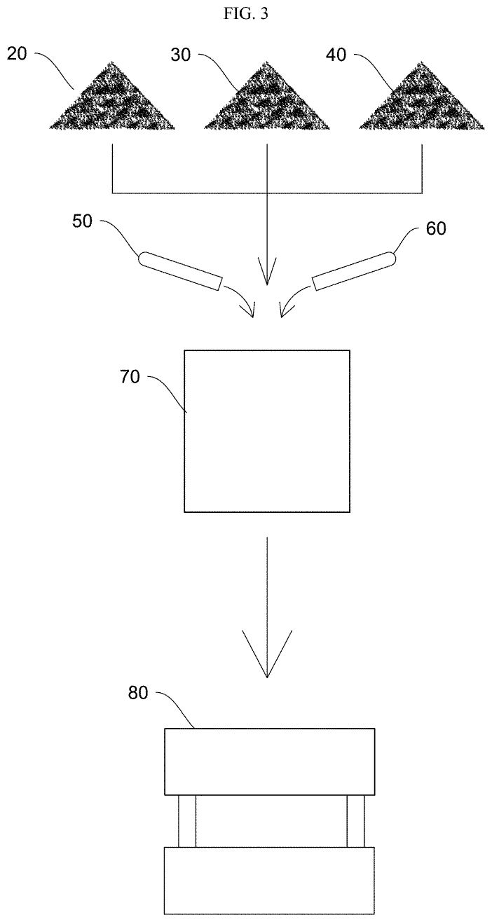

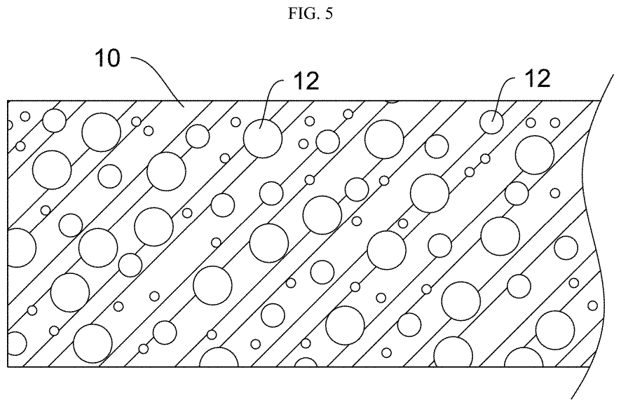

Referring to FIGS. 3-5, the plant fiber foam board 10 is molded from plant fibers 20, Ethylene Vinyl Acetate (EVA) copolymer 30, calcium carbonate 40, blowing agent 50, and cross-linking agent 60 in a high temperature and a high pressure. The plant fiber foam board 10 includes multiple air holes 12 foamed thereon, wherein the multiple air holes 12 do not communicate with one another. Thereby, the plant fiber foam board 10 of the present invention has flexibility and sound insulation.

In another preferred embodiment, the plant fiber foam board 10 is molded from the plant fibers 20, the EVA copolymer 30, and the calcium carbonate 40. A weight percent of the plant fibers 20 is 30 wt % to 65 wt %, a weight percent of the EVA copolymer 30 is 15 wt % to 70 wt %, and a weight percent of the calcium carbonate 40 is 15 wt % to 35 wt % so as to reduce a consumption of the EVA copolymer 30. Preferably, the weight percent of the plant fibers 20 is 50 wt %, the weight percent of the EVA copolymer 30 is 15 wt %, and the weight percent of the calcium carbonate 40 is 15 wt % so as to reduce the consumption of the EVA copolymer 30 and to obtain the flexibility and water resistance.

The plant fibers 20 are made of powdered plant fibers by grinding agricultural waste material, and the agricultural waste material is at least one of rice husk, wheat husk, sugarcane bagasse, cornstalk, and rice stalk, such that the plant fiber foam board 10 is decomposed in nature to reduce consumption of the EVA copolymer 30.

The EVA copolymer 30 is the copolymer of ethylene and vinyl acetate so as to obtain softness, the flexibility, and chemical stability.

The calcium carbonate 40 facilitates foaming and reducing melt deformation to decrease a diameter of each of the multiple air holes 12.

The blowing agent 50 is azodicarbonamide (ADCA) to obtain the softness and the flexibility of the plant fiber foam board 10, wherein a diameter of each of the multiple air holes 12 is 20 μm to 100 μm to obtain the flexibility and moisture resistance of the plant fiber foam board 10.

A weight percent of the blowing agent 50 is 5 wt % to 15 wt % so as to control a number of the multiple air holes 12 and the diameter of each air hole 12. The weight percent of the blowing agent 50 is 7 wt %.

A weight percent of the cross-linking agent 60 is 1 wt % to 3 wt %, wherein the cross-linking agent 60 is organic peroxide, such as BIPB (bis(tert-butylperoxy isopropyl)benzene) so as to avoid spreading odor of the plant fiber foam board.

Referring to FIG. 3, the plant fibers 20, the EVA copolymer 30, the calcium carbonate 40, the blowing agent 50, and the cross-linking agent 60 are put and mixed in a kneader reactor 70 for 10 minutes to 20 minutes in a temperature of 120° C. to 140° C.

Then, the plant fibers 20, the EVA copolymer 30, the calcium carbonate 40, the blowing agent 50, and the cross-linking agent 60 are removed from the kneader reactor 70 and are put into in the mold of a foaming machine 80 to be heated and pressurized, thus foaming the multiple air holes 12.

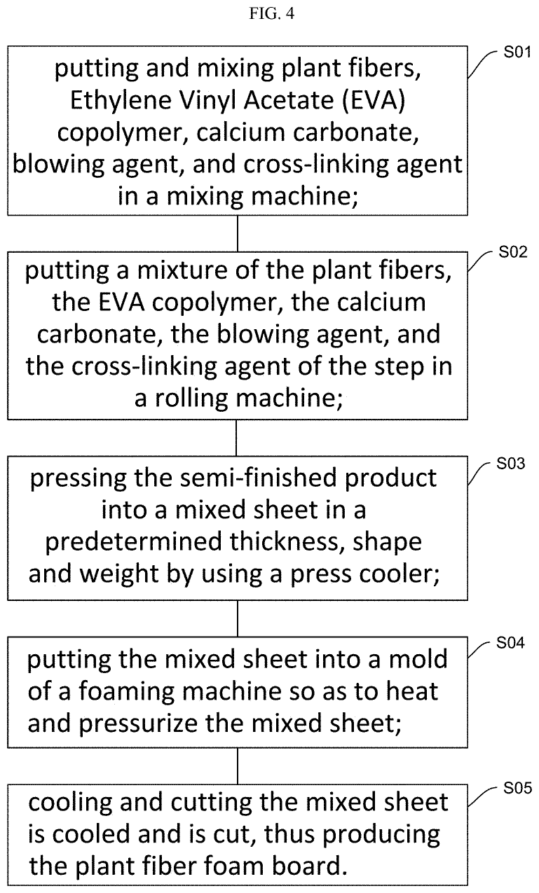

As shown in FIG. 4, a method of making the plant fiber foam board 10 comprises steps of:

S01, putting and mixing plant fibers 20, Ethylene Vinyl Acetate (EVA) copolymer 30, calcium carbonate 40, blowing agent 50, and cross-linking agent 60 in a mixing machine so as to produce a semi-finished product, wherein the mixing machine is the kneader reactor 70 which is comprised of a cylinder, a mixing shaft, a fixing plate, a cover, and a pair of rotatable mixing blades configured to mix the plant fibers 20, the EVA copolymer 30, the calcium carbonate 40, the blowing agent 50, and the cross-linking agent 60, wherein a programmable logic controller (PLC) is configured to precisely control and record a mixing temperature, a mixing time, and a mixing adhesion of the plant fibers 20, the EVA copolymer 30, the calcium carbonate 40, the blowing agent 50, and the cross-linking agent 60. Preferably, the mixing time is 10 minutes to 14 minutes, and the mixing temperature is 120° C. to 140° C.;

S02, putting a mixture of the plant fibers 20, the EVA copolymer 30, the calcium carbonate 40, the blowing agent 50, and the cross-linking agent 60 of the step S01 in a rolling machine (not shown) so as to roll and to disperse the mixture, wherein the step S02 can be also skipped after the step S01;

S03, pressing the semi-finished product into a mixed sheet in a predetermined thickness, shape and weight by using a press cooler (not shown), wherein the step S03 can be skipped; and

S04, putting the mixed sheet into a mold of a foaming machine 80 so as to heat and pressurize the mixed sheet, such that multiple air holes 12 are foamed on the mixed sheet, and the multiple air holes 12 do not communicate with one another.

Preferably, the semi-finished product is put and mixed in the rolling machine before the S04.

Preferably, the mixing machine is the kneader reactor 70, the mixing time is 10 minutes to 14 minutes, and the mixing temperature is 120° C. to 140° C.

Preferably, a weight percent of the plant fibers 20 is 30 wt % to 65 wt %, a weight percent of the EVA copolymer 30 is 15 wt % to 70 wt %, and a weight percent of the calcium carbonate 40 is 15 wt % to 35 wt %.

The weight percent of the plant fibers 20 is 50 wt %, the weight percent of the EVA copolymer 30 is 15 wt %, and the weight percent of the calcium carbonate 40 is 15 wt %.

A diameter of each air hole is 20 μm to 100 μm.

The plant fibers are made of powdered plant fibers by grinding at least one of rice husk, wheat husk, sugarcane bagasse, cornstalk, and rice stalk.

Preferably, the blowing agent is azodicarbonamide (ADCA).

Preferably, the weight percent of the blowing agent is 7 wt %.

Preferably, the cross-linking agent 60 is organic peroxide, such as BIPB (bis(tert-butylperoxy isopropyl)benzene).

The method of making the plant fiber foam board 10 further comprises a step of S05, wherein the mixed sheet is cooled and is cut, thus producing the plant fiber foam board 10, such as any one of sleeping mat, yoga mat, placemat, soft floor, soundproof board, and car mat.

Accordingly, the plant fiber foam board of the present invention is decomposed in nature and has flexibility and sound insulation.

Note that the specifications relating to the above embodiments should be construed as exemplary rather than as limitative of the present invention, with many variations and modifications being readily attainable by a person of average skill in the art without departing from the spirit or scope thereof as defined by the appended claims and their legal equivalents.

### Example

The claimed plant fiber foam board has been submitted for testing (1) Polycyclic Aromatic Hydrocarbons contents, (2) EN 71 Part 3:2013+A1:2014+A2:2017+A3:2018 Migration of Certain Elements, (3) Phthalate content in accordance with Annex 17 of REACH Regulation (EC) No 1907/2006, and (4) DNHP content.

Table 1 below, shows the test results of Polycyclic Aromatic Hydrocarbons contents. Table 2 shows requirements of GS PAHs.

Method: With reference to AfPS GS 2014:01 PAK method. Analysis was performed by GC/MS.

TABLE 1

| Test items | Unit | MDL | 1 |
|---|---|---|---|
| Acenaphthene (CAS No.: 83-32-9) | mg/kg | 0.2 | N.D. |
| Acenaphthylene (CAS No.: 208-96-8) | | 0.2 | N.D. |
| Anthracene (CAS No.: 120-12-7) | | 0.2 | N.D. |
| Benzo[a]anthracene (CAS No.: 56-55-3) | | 0.2 | N.D. |
| Benzo[a]pyrene (CAS No.: 50-32-8) | | 0.2 | N.D. |
| Benzo[b]fluoranthene (CAS No.: 205-99-2) | | 0.2 | N.D. |
| Benzo[g,h,i]perylene (CAS No.: 191-24-2) | | 0.2 | N.D. |
| Benzo[k]fluoranthene (CAS No.: 207-08-9) | | 0.2 | N.D. |
| Chrysene (CAS No.: 218-01-9) | | 0.2 | N.D. |
| Dibenzo[a,h]anthracene (CAS No.: 53-70-3) | | 0.2 | N.D. |
| Fluoranthene (CAS No.: 206-44-0) | | 0.2 | N.D. |
| Fluorene (CAS No.: 86-73-7) | | 0.2 | N.D. |
| Indeno[1,2,3-c,d] pyrene (CAS No.: 193-39-5) | | 0.2 | N.D. |
| Naphthalene (CAS No.: 91-20-3) | | 0.2 | N.D. |
| Phenanthrene (CAS No.: 85-01-8) | | 0.2 | N.D. |
| Pyrene (CAS No.: 129-00-0) | | 0.2 | N.D. |
| Benzo[j]fluoranthene (CAS No.: 205-82-3) | | 0.2 | N.D. |
| Benzo[e]pyrene (CAS No.: 192-97-2) | | 0.2 | N.D. |
| Sum of 18 PAHs | | — | N.D. |

AfPS (German commission for Product Safety): GS PAHs requirements

TABLE 2

| | | Category 2 | | Category 3 | |
|---|---|---|---|---|---|
| | | Materials not falling | | Materials not falling | |
| | | under category 1 with | | under category 1 or 2 with | |
| | Categ | foreseeable contact to skin | | foreseeable contact to skin | |
| | Material indented | for longer than 30 seconds | | for less than 30 seconds | |
| | to be put in the | (long-term skin contact). | | (short-term skin contact). | |
| | mouth or toys | | Other | | Other |
| | with intended | | products | | products |
| | skin contact | Toy under | under | Toy under | under |
| Parameter | (longer than 30 s). | 2009/48/EC | ProdSG | 2009/48/EC | ProdSG |
| Naphthalene | <1 | <2 | | <10 | |
| Acenaphthylene | <1 Sum | <5 Sum | <10 Sum | <20 Sum | <50 Sum |
| Acenaphthene | | | | | |
| Fluorene | | | | | |
| Phenanthrene | | | | | |
| Anthracene | | | | | |
| Fluoranthene | | | | | |
| Pyrene | | | | | |
| Benzo[a]anthracene | <0.2 | <0.2 | <0.5 | <0.5 | <1 |
| Chrysene | <0.2 | <0.2 | <0.5 | <0.5 | <1 |
| Benzo[b]fluoranthene | <0.2 | <0.2 | <0.5 | <0.5 | <1 |
| Benzo[j]fluoranthene | <0.2 | <0.2 | <0.5 | <0.5 | <1 |
| Benzo[k]fluoranthene | < | <0.2 | <0.5 | <0.5 | <1 |
| Benzo[a]pyrene | < | <0.2 | <0.5 | <0.5 | <1 |
| Benzo[e]pyrene | < | <0.2 | <0.5 | <0.5 | <1 |
| Indeno[1,2,3-c,d] | <0.2 | <0.2 | <0.5 | <0.5 | <1 |
| Dibenzo[a,h]anthrace | <0.2 | <0.2 | <0.5 | <0.5 | <1 |
| Benzo[g,h,i]perylene | <0.2 | <0.2 | <0.5 | <0.5 | <1 |
| Sum of 18 PAH | <1 | <5 | <10 | <20 | <50 |

Table 3 and Table 4, below, show the Scrapped-off material test results.

### European Standard—Safety of Toys: EN 71 Part 3:2013+A1:2014+A2:2017+A3:2018—

### Migration of Certain Elements

### Category III: Scrapped-Off Toy Material

Method: With reference to EN 71 Part 3:2013+A1:2014+A2:2017+A3:2018. Analysis of general elements was performed by ICP-MS. Extractable Organic Tin was analyzed by GC-MS. Extractable Chromium III & Chromium VI were analyzed by LC-ICP-MS.

TABLE 3

| | | Result | | Permissible |
|---|---|---|---|---|
| | | (mg/kg) | RL | Limit |
| Test Items | | 1 | (mg/kg) | (mg/kg) |
| Soluble Aluminum | (Al) | N.D. | 50 | 70,000 |
| Soluble Antimony | (Sb) | N.D. | 10 | 560 |
| Soluble Arsenic | (As) | N.D. | 10 | 47 |
| Soluble Barium | (Ba) | N.D. | 50 | 18,750 |
| Soluble Boron | (B) | N.D. | 50 | 15,000 |
| Soluble Cadmium | (Cd) | N.D. | 5 | 17 |
| Soluble Cobalt | (Co) | N.D. | 10 | 130 |
| Soluble Copper | (Cu) | N.D. | 50 | 7,700 |
| Soluble Lead | (Pb) | N.D. | 10 | 23 |
| Soluble Manganese | (Mn) | N.D. | 50 | 15,000 |
| Soluble Mercury | (Hg) | N.D. | 10 | 94 |
| Soluble Nickel | (Ni) | N.D. | 10 | 930 |
| Soluble Selenium | (Se) | N.D. | 10 | 460 |
| Soluble Strontium | (Sr) | N.D. | 50 | 56,000 |
| Soluble Tin | (Sn) | N.D. | 4.9 | 180,000 |
| Soluble Zinc | (Zn) | N.D. | 50 | 46,000 |
| Soluble Chromium (III) | (Cr (III)) | N.D. | 5 | 460 |
| Soluble Chromium (VI) | (Cr (VI)) | N.D. | 0.18 | 0.2 |
| Soluble Organic Tin^{#} | — | N.D. | — | 12 |

TABLE 4
Remark: #

| | | Soluble Organic Tin Result(s) | MDL |
|---|---|---|---|
| Test Items | | 1 | (mg/kg) |
| Methyl tin | (MeT) | N.D. | 0.5 |
| Di-n-propyl tin | (DProT) | N.D. | 0.5 |
| Butyl tin | (BuT) | N.D. | 0.5 |
| Dibutyl tin | (DBT) | N.D. | 0.5 |
| Tributyl tin | (TBT) | N.D. | 0.5 |
| n-Octyl tin | (MOT) | N.D. | 0.5 |
| Tetrabutyl tin | (TeBT) | N.D. | 0.5 |
| Di-n-octyl tin | (DOT) | N.D. | 0.5 |
| Diphenyl tin | (DPhT) | N.D. | 0.5 |
| Triphenyl tin | (TPhT) | N.D. | 0.5 |

Table 5, below, shows the test results of the Phthalate contents.

Method: With reference to EN 14372. Analysis was performed by GC/MS.

TABLE 5

| | | Test Results | Detected | |
|---|---|---|---|---|
| Test Item | CAS NO. | 1 | Limit | Unit |
| DBP (Di-butyl | 000084-74-2 | N.D. | 0.003 | % |
| phthalate) | | | | |
| BBP (Benzyl butyl | 000085-68-7 | N.D. | 0.003 | % |
| phthalate) | | | | |
| DEHP (Di-(2- | 000117-81-7 | N.D. | 0.003 | % |
| ethylhexyl) phthalate) | | | | |
| DIDP (Di-isodecyl | 026761-40-0/ | N.D. | 0.01 | % |
| phthalate) | 068515-49-1 | | | |
| DINP (Di-isononyl | 028553-12-0/ | N.D. | 0.01 | % |
| phthalate) | 068515-48-0 | | | |
| DNOP (Di-n-octyl | 000117-84-0 | N.D. | 0.003 | % |
| phthalate) | | | | |

Table 6, below, shows the test results of DNHP content.

Method: With reference to EN 14372. Analysis was performed by GC/MS.

TABLE 6

| | | Test Results | Detected | |
|---|---|---|---|---|
| Test Item | CAS NO. | 1 | Limit | Unit |
| DNHP | 84-75-3 | N.D. | 0.003 | % |
| (Di-n-hexyl phthalate) | | | | |

Note of the Test:

1. mg/kg=ppm

2. N.D.=NOT Detected

3. RL=Reporting Limit

4. MDL=Method Detection Limit

5. “-”=Not Regulated

6. The chemical analysis was conducted in SGS Taiwan Ltd. Chemical Laboratory-Taipei.

Having described the invention in detail, it will be apparent that modifications and variations are possible without departing from the scope of the invention defined in the appended claims.

When introducing elements of the present invention or the preferred embodiments thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A plant fiber foam board comprising:
plant fibers, Ethylene Vinyl Acetate (EVA) copolymer, calcium carbonate, a blowing agent, and a cross-linking agent, which are mixed and molded in a high temperature and a high pressure, wherein the plant fiber foam board includes multiple air holes foamed therein, and wherein the multiple air holes do not communicate with one another.

2. The plant fiber foam board according to claim 1, wherein the plant fiber foam board comprises:
a weight percentage of the plant fibers from about 30 wt % to about 65 wt %;
a weight percentage of the EVA copolymer from about 15 wt % to about 70 wt %; and
a weight percentage of the calcium carbonate from about 15 wt % to about 35 wt %.

3. The plant fiber foam board according to claim 2, wherein the weight percentage of the plant fibers is about 50 wt %, the weight percentage of the EVA copolymer is about 15 wt %, and the weight percentage of the calcium carbonate is about 15 wt %.

4. The plant fiber foam board according to claim 1, wherein a diameter of each of the multiple air holes is from about 20 μm to about 100 μm.

5. The plant fiber foam board according to claim 1, wherein the plant fibers are made of powdered plant fibers by grinding agricultural waste material; and the agricultural waste material is at least one of rice husk, wheat husk, sugarcane bagasse, cornstalk, and rice stalk.

6. The plant fiber foam board according to claim 1, wherein the blowing agent is azodicarbonamide (ADCA).

7. The plant fiber foam board according to claim 1, wherein the cross-linking agent is organic peroxide, and the organic peroxide is BIPB (bis(tert-butylperoxy isopropyl)benzene).

8. A method of making the plant fiber foam board comprising:
mixing, by a mixing machine, plant fibers, Ethylene Vinyl Acetate (EVA) copolymer, calcium carbonate, a blowing agent, and a cross-linking agent so as to produce a semi-finished product;
putting the semi-finished product into a mold of a foaming machine;
heating and pressurizing, by the foaming machine, the semi-finished product so as to foam multiple air holes in the semi-finished product, and the multiple air holes do not communicate with one another.

9. The method according to claim 8, further comprising mixing, by a rolling machine, the semi-finished product before putting the semi-finished product into the mold of the foaming machine.

10. The method according to claim 8, wherein the mixing machine is a kneader reactor configured to mix the plant fibers, the EVA copolymer, the calcium carbonate, the blowing agent, and the cross-linking agent, wherein a mixing time of the plant fibers, the EVA copolymer, the calcium carbonate, the blowing agent, and the cross-linking agent is from about 10 minutes to about 14 minutes, and wherein a mixing temperature of the plant fibers, the EVA copolymer, the calcium carbonate, the blowing agent, and the cross-linking agent is from about 120° C. to about 140° C.

11. The method according to claim 8, wherein the plant fiber foam board comprises:
a weight percentage of the plant fibers from about 30 wt % to about 65 wt %;
a weight percentage of the EVA copolymer from about 15 wt % to about 70 wt %; and
a weight percentage of the calcium carbonate from about 15 wt % to about 35 wt %.

12. The method according to claim 8, wherein the weight percentage of the plant fibers is about 50 wt %, the weight percentage of the EVA copolymer is about 15 wt %, and the weight percentage of the calcium carbonate is about 15 wt %.

13. The method according to claim 8, wherein a diameter of each of the multiple air holes is from about 20 μm to about 100 μm.

14. The method according to claim 8, wherein the plant fibers are made of powdered plant fibers by grinding agricultural waste material, and the agricultural waste material is at least one of rice husk, wheat husk, sugarcane bagasse, cornstalk, and rice stalk.

15. The plant fiber foam board according to claim 8, wherein the blowing agent is azodicarbonamide (ADCA).

16. The plant fiber foam board according to claim 15, wherein a weight percentage of the blowing agent is about 7 wt %.

17. The plant fiber foam board according to claim 1, wherein the cross-linking agent is organic peroxide, and the organic peroxide is BIPB (bis(tert-butylperoxy isopropyl)benzene).
